(19) United States
(12) Patent Application Publication
(10) Pub. No.: US 2003/0163788 A1
(43) Pub. Date: Aug. 28, 2003

(54) Structured design documentation importer

(76) Inventor: Jim Dougherty, Richardson, TX (US)

Correspondence Address: David W. Carstens, P.O. Box 802334, Dallas, TX, 75380-2334, US

(21) Appl. No.: 10/080,778

(22) Filed: Feb. 22, 2002

(51) Int. Cl. G06F 17/21

(52) U.S. Cl. 715/523; 715/513

(57) ABSTRACT

A method, computer program product, and data processing system for importing test specifications from a design document into testing software for performing testing in a manufacturing environment is disclosed. A design document is written in a structured format, within a spreadsheet, word-processor document, XML file, or other document. Importer software extracts the testing information from the structured format and translates the information into a format that is readable by testing software. The translated information is then submitted to the testing software for testing the product described in the design document.

### BACKGROUND OF THE INVENTION

1. Technical Field

The present invention is related generally to the preparation of tests in a manufacturing environment. More specifically, the present invention is directed toward the importation of testing specifications from a design specification document.

2. Description of Related Art

The components of design documentation that are used in the specification of manufacturing requirements must be translated precisely into the applicable manufacturing processes in order to correctly implement design intent. Any errors in this regard could lead to a defective product being shipped to customers or an acceptable product inadvertently being categorized as defective.

Consider for example the specification of electrical test limits. If incorrect test limits are included in a test program and defective product inadvertently passes a test operation because of this error, a defective product is shipped to customers. This error can occur when, for whatever reason, the test engineer is not applying the correct test limits from the design documentation. Sometimes this error occurs because new design documentation has been released, and the test program has not been updated to reflect this change. Other times this error results because the test engineer incorrectly enters the limits into the test software program.

The traditional approach of translating design documentation into applicable manufacturing processes is to manually reenter design information into a medium suitable for a specific manufacturing process. Design documentation is typically in a format appropriate for users of desktop application programs such as word processors, spreadsheets, or CAD (Computer Aided Design) applications. Manufacturing information used to control a manufacturing process directly, on the other hand, is typically in a custom format suitable for a particular piece of equipment such as a software program in a test system. Sometimes a software tool is available to electronically link subsets of the design documentation such as test limits. But in the case of manufacturing test requirements, there is currently no way to electronically import all of the relevant elements of manufacturing test requirements (including, for example, the testing method and test conditions) from a design document. Thus, it would be desirable to be able to import testing specifications directly from a design document.

### SUMMARY OF THE INVENTION

The present invention provides a method, computer program product, and data processing system for importing test specifications from a design document into testing software for performing testing in a manufacturing environment. A design document is written in a structured format, within a spreadsheet, word-processor document, XML file, or other document. Importer software extracts the testing information from the structured format and translates the information into a format that is readable by testing software. The translated information is then submitted to the testing software for testing the product described in the design document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram depicting a hardware system that may be used to carry out processes of the present invention in a preferred embodiment;

FIG. 2 is a high-level flow diagram depicting the basic process followed in a preferred embodiment of the present invention;

FIG. 3 depicts an EXCEL® workbook 300 containing worksheets representing design/test specifications of a given product platform to be imported into test software in accordance with a preferred embodiment of the present invention;

FIG. 4 is flowchart representation of a process followed by an importer in accordance with a preferred embodiment of the present invention;

FIG. 5 is a diagram depicting a dialog box for entry of information identifying a product platform, product code, and test operation in accordance with a preferred embodiment of the present invention;

FIG. 6 depicts a table of test specifications as imported into a test executive and displayed through a graphical user interface (GUI) in accordance with a preferred embodiment of the present invention;

FIG. 7 provides an expanded view of a particular test in accordance with a preferred embodiment of the present invention;

FIG. 8 is a diagram depicting an expanded view showing a user-defined test specification type in accordance with a preferred embodiment of the present invention;

FIG. 9 is a diagram showing a list of fundamental characteristics imported into test executive software in accordance with a preferred embodiment of the present invention;

FIG. 10 is a diagram depicting a portion of LABVIEW test library program that may be used in accordance with a preferred embodiment of the present invention; and

FIG. 11 is a flow diagram depicting how a test program settings exporter may be used in a design and manufacturing context in accordance with a preferred embodiment of the present invention.

### DETAILED DESCRIPTION OF THE INVENTION

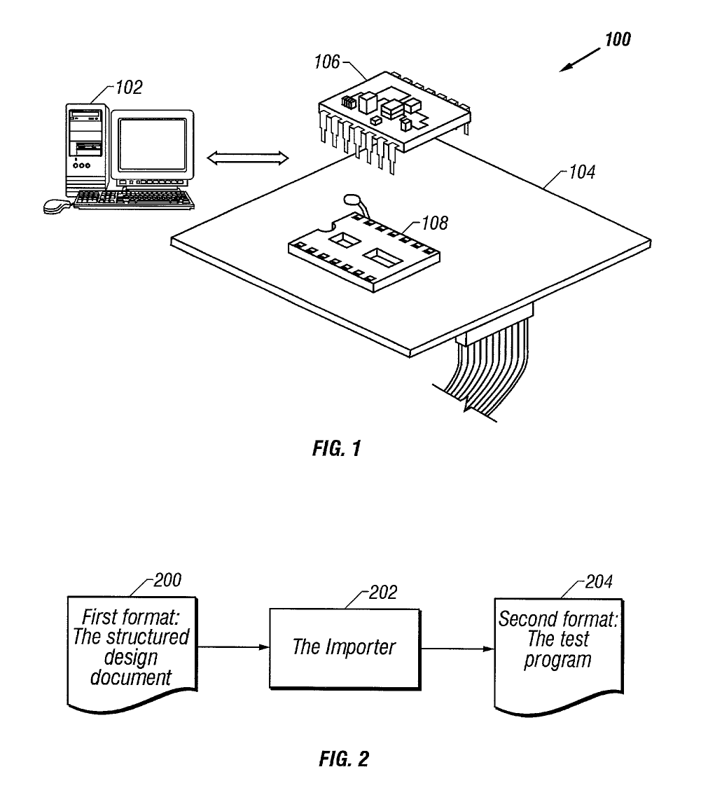

FIG. 1 is a diagram depicting a hardware system 100 that may be used to carry out processes of the present invention in a preferred embodiment. Computer 102 is in communication with and in control of a piece of testing equipment 104, which in this case is a device for performing tests on an integrated power-supply module 106. Power-supply module 106 is placed within a zero-insertion-force socket 108 for testing. To test power-supply module 106, electrical signals are applied to power-supply module 106 through zero-insertion-force socket 108 under the control of computer 102. The behavior of power supply module 106 is monitored and recorded by computer 102, which determines whether power supply module 106 has passed the test by complying with a set of test specifications provided to computer 102.

One of ordinary skill in the art will appreciate that hardware system 100 is paradigmatic of a large number of various types of computer-controlled tests and that the actual hardware depicted in FIG. 1 is merely a demonstration of a particular embodiment. In actuality, testing equipment 104 could be any type of computer-controlled testing equipment: electrical, chemical, mechanical, biometric, or any other computer-controlled testing equipment could be used without departing from the scope or spirit of the invention. One of ordinary skill in the art will also recognize that the term “computer” can be interpreted broadly without departing from the scope or spirit of the invention. The term “computer” should be understood in a more general sense, as a device that performs computations, rather than as a particular choice of hardware components. While a conventional personal computer or workstation (102) is depicted in FIG. 1, any of a broad range of computing devices could be used in place of computer 102, including an embedded computer or microcontroller incorporated into testing equipment 104.

The present invention provides a method, computer program product, and data processing system for importing test specifications from a design document into testing software for performing testing in a manufacturing environment. FIG. 2 is a high-level flow diagram depicting the basic process followed in a preferred embodiment of the present invention. A design document is written in a structured format, within a spreadsheet, word-processor document, XML file, or other document (step 200). Importer software extracts the testing information from the structured format and translates the information into a format that is readable by testing software (step 202). The translated information is then submitted to the testing software for testing the product described in the design document (step 204).

In the case of a manufacturing test process, the relevant design information and testing specifications typically include, but are not limited to, the following elements:

1. Product Platform

A designer may wish to group similar products into a product platform. This information can be used to associate to a specific test function library.

2. Product Code

The product code should be visibly displayed on the operator display so the test operator can confirm the product they are testing.

3. Revision Number

The revision number can also be displayed on the operator display to confirm the current design documentation number. This is especially important in ISO auditing to allow an auditor to confirm the current revision number against the latest version.

4. Fundamental Characteristics of the Product

These are characteristics that define the overall characteristics of the product that may be useful in performing the tests. For example, a DC nominal output voltage of a power supply being tested could be used to scale the output voltage result in terms of percent from nominal if required by a particular Test Method (see 7, below).

5. Test List Including Sequence of Tests

These are the specific tests required to test product conformity. The exact sequence may be important to ensure acceptable operation.

6. Test Name

The test name is important in order to provide a unique mapping of names in the design documentation to the test results. In this manner, follow-up data analysis can be unambiguously related to the design documentation.

7. Test Method

The test method defines the method required to perform the test as specified by the designer. This ensures that the test result has been obtained using correct procedures.

8. Test Description

The test description provides a field to elaborate the nature of the test being performed. Having this information available in the test program helps clarify the nature of the test at the test station without having to refer back to the design document.

9. Test Conditions

Test conditions specify the stimulus for performing the test, and are used by the test programmer to set the instruments to the correct conditions. Each condition should include the name, the value and units of the condition to ensure proper implementation. The Test Method itself may imply a unique condition, or one or more conditions may be specified depending on the test.

10. Test Limits

Once a measurement is taken for each test, it must be compared to limits that define conformance to specification. Test limits should also include units of measurement to ensure proper application of pass/fail status and to unambiguously report results. In general, both a minimum and maximum limit is defined.

11. Resolution of Digits (Numerical Precision)

It is important for the designer to correctly convey the required resolution with both Test Conditions and Test Limits in order to obtain the desired accuracy. This is uniquely defined in the design documentation by showing the numbers with the desired decimal point placement and trailing zeros. The resulting importer then can uncover this information through software, and apply appropriately in the test program.

In summary, the present invention provides a way to unambiguously translate deign documentation into a manufacturing test process. Among the errors that are eliminated by use of the present invention are any recurring typographical errors, or errors that occur when an incorrect design documentation version is referenced. The methodology requires a structured design documentation format and an importer that translates this information into a format suitable for use during the manufacturing/testing process. The importer is preferably in the form of a program of functional descriptive material recorded on a computer-readable medium. The functional descriptive material may include instructions, rules (such as rules of inferences), formulas, functions, queries, statements, databases (including deductive databases), or any other computer-readable data that when executed by a computer, enables the computer to act in accordance with the processes of the present invention. Once an importer has been written and verified for correctness, it can be used to import test specifications from the structured design document. Besides eliminating mistakes, this approach also saves time. The test engineer no longer must retype the design documentation into the test program. The software importer provides this function, and the tedium of typing information is eliminated.

A preferred embodiment of the present invention translates information from a design document in a structured format into a format suitable for use in a test process. It is necessary for a full understanding of the invention, therefore, to understand what is meant by a structured format. A structured format is a data format or document format that contains both data and metadata. Data is simply any kind of information. Metadata is information that imposes organization, structure, or meaning on the data. Metadata is often referred to as “data about the data.”

Metadata is best understood by example. In a table of data, for instance, the headings (such as column headings) and titles are metadata that impose both structure and meaning to the data. For example, an airline table of departure times will likely have the headings “flight number,” “origin,” “destination,” “departure time,” and “arrival time.” Those headings are metadata that serve to both organize (e.g., into columns and rows) and give meaning to the data (e.g., by distinguishing an arrival time from a departure time). Tags in a markup language, such as XML (extensible markup language) or HTML (hypertext markup language) are also metadata. For example, an XML document will have tags that represent different types of data. Metadata also need not be as explicit as tags or headings. For example, a word processor or spreadsheet document into different pages representing different items of data may also be considered as including metadata, where the metadata in this case consists of page separators or page breaks.

Many different structured document formats exist in the art, and it is impossible to enumerate all of the applicable formats. Moreover, it is anticipated that in the future, many new structured formats will be created. For purposes of demonstration, the structured format of a MICROSOFT EXCEL® file is used to describe a preferred embodiment of the present invention, but one of ordinary skill will recognize that any one of a number of structured formats may be used within the present invention.

### Structured Document

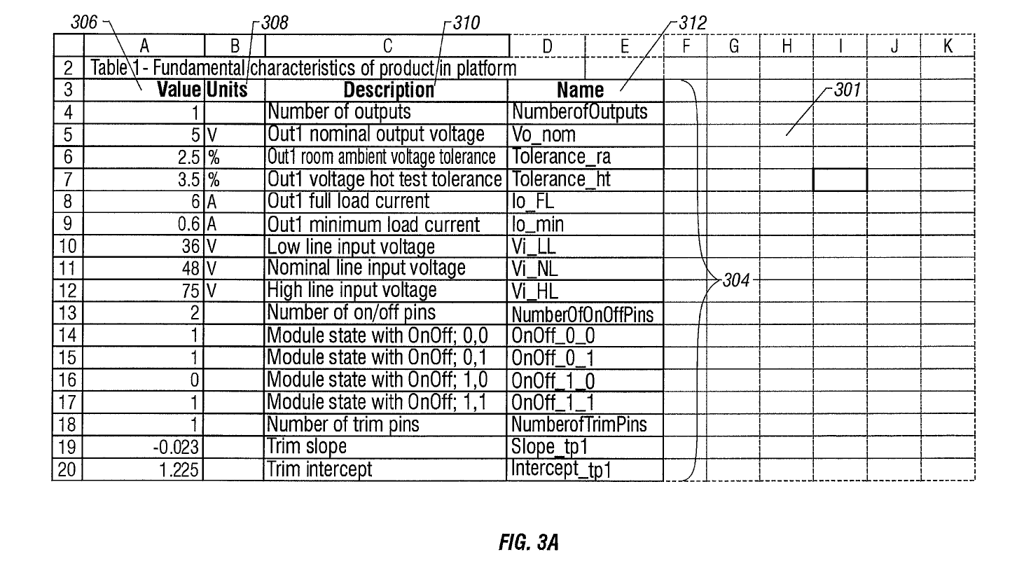

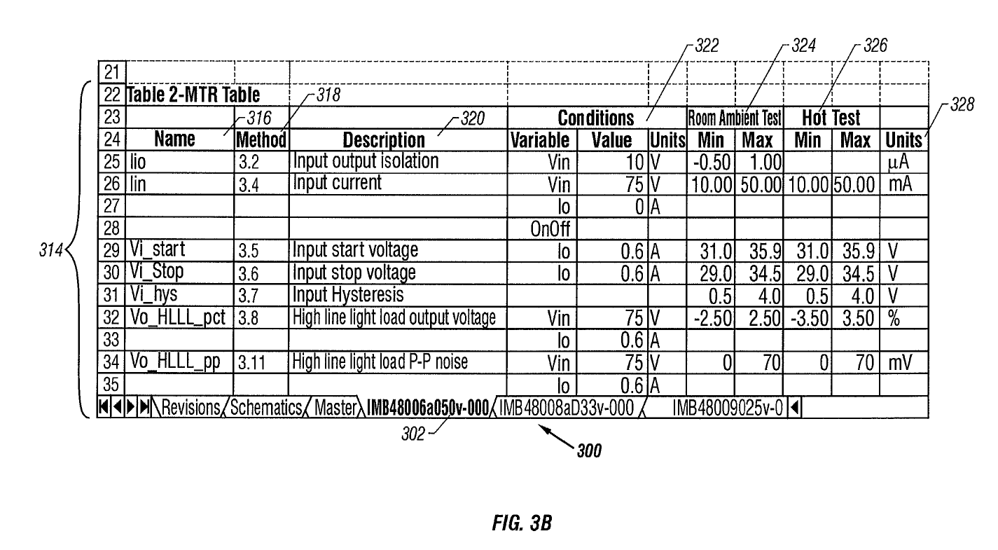

FIG. 3 depicts an EXCEL® workbook 300 containing worksheets representing design/test specifications of a given product platform to be imported into test software in accordance with a preferred embodiment of the present invention. Each worksheet (e.g., 301) represents a different product code of the platform. Worksheet tab names (e.g., 302) represent product codes and the workbook as a whole (300) defines an entire product platform. The worksheet in this example (301) applies to a DC-DC converter product and contains two tables.

Table 1 (304) shows the fundamental characteristics of the product. A value 306 for each characteristic is provided along with a unit of measurement 308 (where applicable), a description of the characteristic 310, and a name for the characteristic 312.

Table 2 (314) contains a list of tests and all of the required information to perform each test. A name of the tested value 316 is provided along with a method number 318, description of the test 320, conditions under which the test will be performed 322, and desired ranges of values (test limits) for a room ambient test 324 and hot test 326, along with the unit of measurement for the tested value 328.

Method number 318 refers to a paragraph number of a separate test methods document controlled by the design organization. Taken together, the documentation uniquely conveys all of the necessary information in a structured format to perform the test. Observe that there are two sets of test limits in this example, one set for a room ambient test (324) and one set for hot test (326). Each set of test limits refers to a separate test operation performed at different times in a manufacturing process. In general, more and/or different test operations may be added as required as long as the corresponding common test step information applies. When a test is to be skipped, the test limit columns are left blank to convey this information to the importing program. In the general case, the specific names used in the tables can be arbitrarily defined to suit a given product implementation.

### Importer

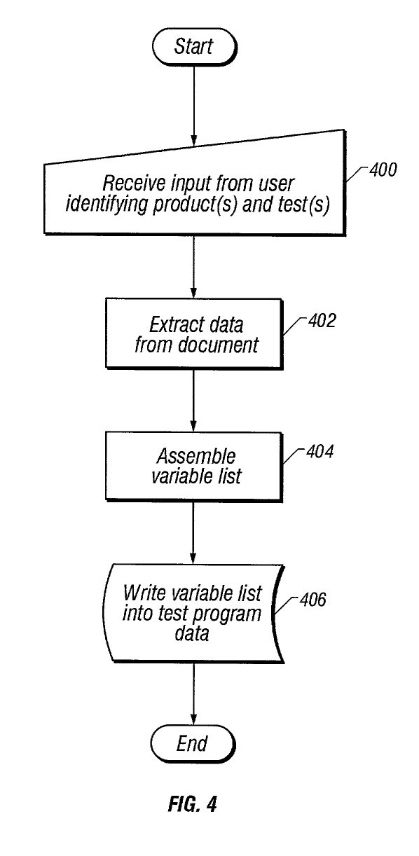

FIG. 4 is flowchart representation of a process followed by an importer in accordance with a preferred embodiment of the present invention. Input is received from a user to identify the product platform(s), product code(s) and test operation(s) to be applied (step 400). Test specification data is extracted from a structured document containing the corresponding design/test specifications (step 402). A variable list containing the values of test parameters is assembled from the extracted data (step 404). Finally, this variable list is written into data to be used by the test program (step 406). In a preferred embodiment, this data will be stored in a database or other file-type used by the specific test program to be used. Alternatively, this data could be stored in memory for immediate use by the program (e.g., through inter-process communication, sockets, mailboxes, or a similar process). Once the importation process is completed, the test process can be initiated to perform the tests using this same information.

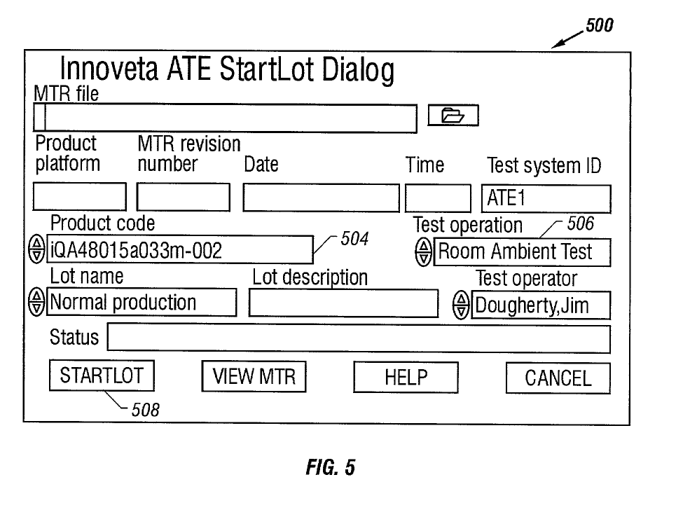

FIG. 5 is a diagram depicting a dialog box 500 for entry of information identifying a product platform, product code, and test operation (step 400 in FIG. 4) in accordance with a preferred embodiment of the present invention. The importer software application selected for this demonstration in written as an add-on to the commercially available application development environment LABVIEW (available from National Instruments, Inc. of Austin, Tex.), but any software capable of performing the importing function can be used such as VISUAL BASIC® (available from Microsoft, Inc, of Redmond, Wash.) or ANSI C.

The test operator (user) selects a document describing the appropriate product platform in text field 502 (the document is an EXCEL® workbook in the illustrated example), and the software populates a “Product Code” control 504 with a list of all tab names of the specified workbook. Based on a particular selection of a product code, a “Test Operation” control 506 is populated with all test operations specified for that product code. The test operator then selects one of these depending on the test operation they are to perform. After all selections are made, the test operator clicks StartLot button 508 and the software imports the documentation into the test program. This process can be further mistake-proofed by scanning in a barcode from a manufacturing ticket that contains all of the required input information.

### Test Program

The test program operating software (also called a test executive) must be capable of passing the imported design documentation into applicable sections of the underlying software. In a preferred embodiment, TESTSTAND, a test executive produced by National Instruments, Inc., is used to perform test sequencing and management, and LABVIEW is used for performing the specific test functions (test library functions), such as controlling instruments and making measurements. One of ordinary skill in the art will recognize that different test executive and/or test library software could be used instead without departing from the scope or spirit of the present invention.

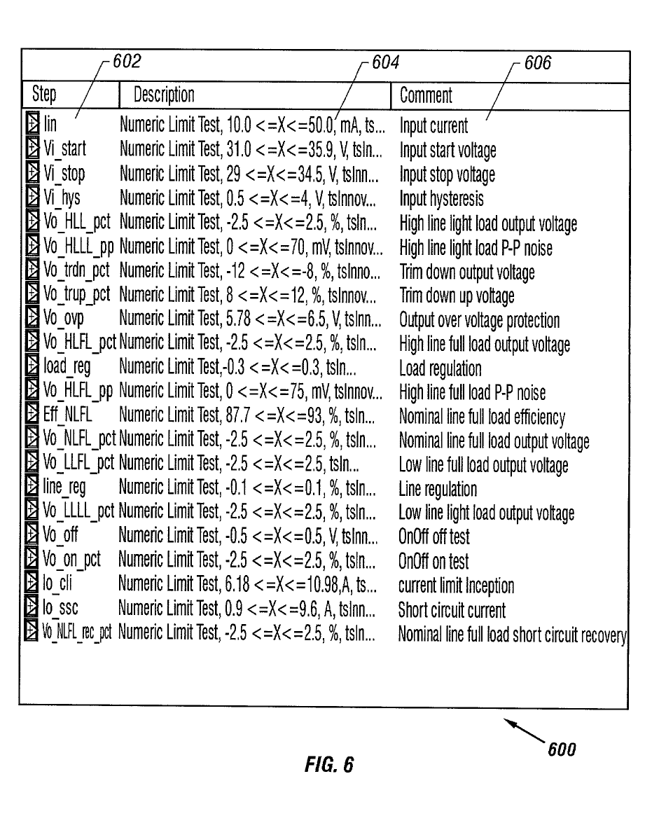

FIG. 6 depicts a table of test specifications 600 as imported into a test executive and displayed through a graphical user interface (GUI) in accordance with a preferred embodiment of the present invention. The test names (602), test limits (604) with units, and test descriptions (606) are shown in this view. In a preferred embodiment, the tests will appear (and thus be performed) in order of their appearance in the original document.

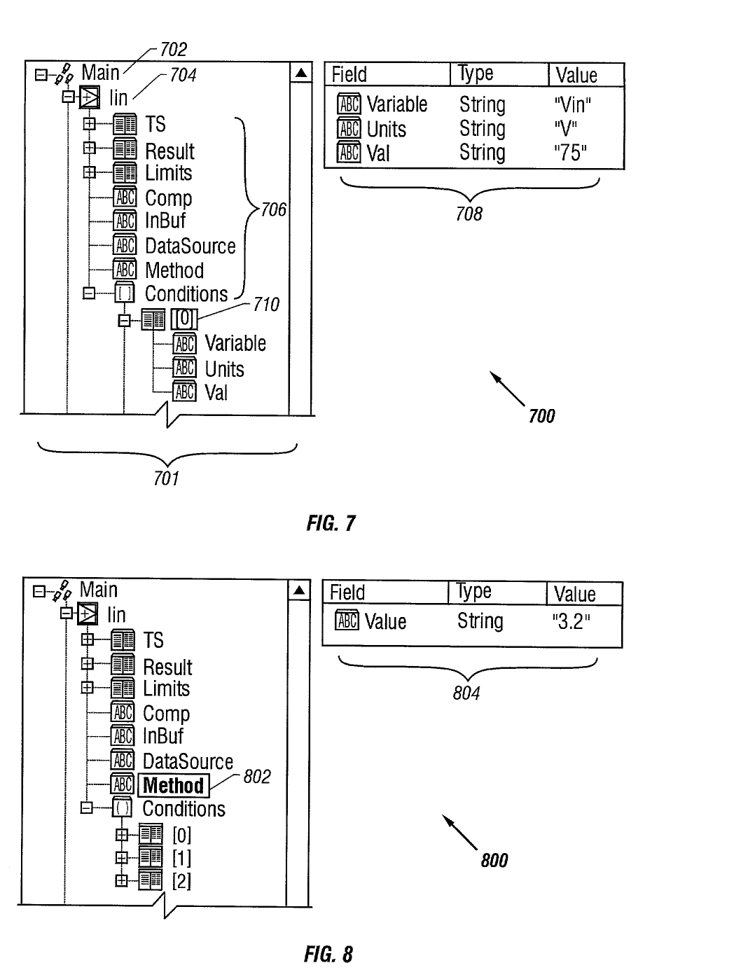

FIG. 7 provides an expanded view 700 of a particular test in table 600 in accordance with a preferred embodiment of the present invention. The testing specifications are shown in a hierarchical (tree) view 701, with a label representing the entire list of tests 702 as the root of the tree and the currently viewed test 704 displayed as a child of root label 702. Other information fields 706 extend from the currently viewed test 704 in a similarly hierarchical manner. A list of individual values 708 appears to the right of hierarchical view 701. List 708 represents values given to an individual set of test conditions represented as label 710 in hierarchical view 701.

The set of test specifications imported into the test executive program may include test specification types that are pre-defined by the test executive program or user-defined test specifications types. FIG. 8 is a diagram depicting an expanded view 800 showing a user-defined test specification type in accordance with a preferred embodiment of the present invention. TESTSTAND software does not pre-define a test specification called “Method” (recall that “Method” in the previous examples refers to paragraph numbers in an external testing document). Therefore, a user-defined specification “Method” 802 must be defined to contain the imported method information (804).

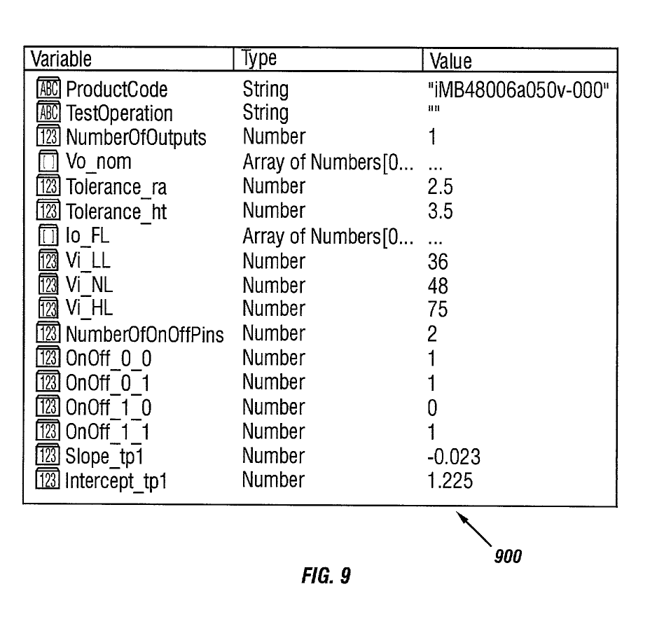

In addition to information imported for each individual test, fundamental characteristics (see 304 in FIG. 3) that define specifications that are common to all of the imported tests may also be imported. FIG. 9 is a diagram showing a list (900) of such fundamental characteristics imported into test executive software in accordance with a preferred embodiment of the present invention.

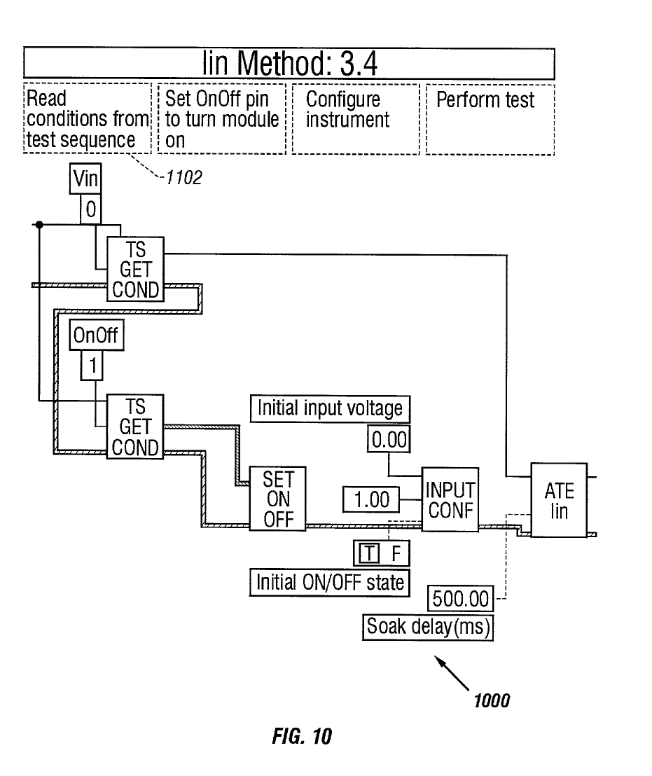

In a preferred embodiment, test executive software will, upon request, automatically invoke test library software perform the specified tests in accordance with the imported test specifications. FIG. 10 is a diagram depicting a portion of LABVIEW test library program that may be used in accordance with a preferred embodiment of the present invention. LABVEW allows test programs to be written in diagram form. Diagram 1000 is a screenshot from LABVIEW showing portion of one such program in which test specifications may be imported. Box 1102 shows that the test specifications are read from a test sequence provided by the test executive.

When a particular test library test function is executed to perform a test, it uses only the information that was originally obtained from the correct version of the design documentation. The measured results are subsequently passed back to the test executive to make a pass/fail decision based on limits originally imported from the design document. In a preferred embodiment, the sequencing of tests follows exactly the sequence of the design document, according to the order in which imported data is stored for use by the text executive.

### Exporter

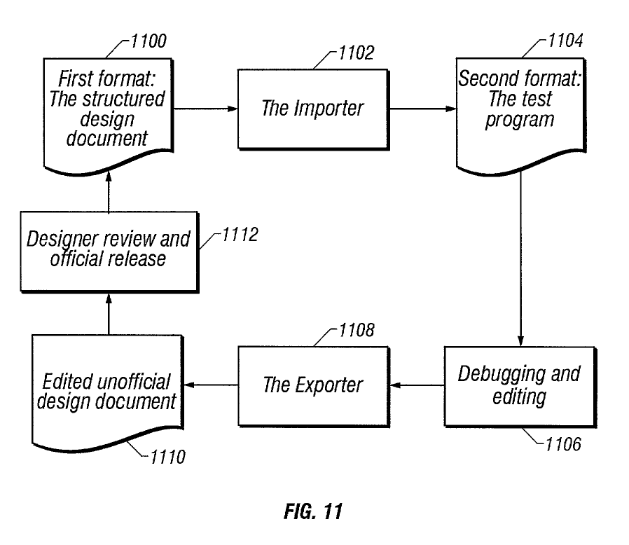

An additional feature can be added to export test program settings back to the design document. FIG. 11 is a flow diagram depicting how a test program settings exporter may be used in a design and manufacturing context in accordance with a preferred embodiment of the present invention.

As before, a design document is written in a structured format (step 1100). Importer software extracts the testing information from the structured format and translates the information into a format that is readable by testing software (step 1102). The translated information is then submitted to the testing software for testing the product (step 1104). The imported test information may be debugged and edited using test executive software in the event that the original design document contains mistakes (step 1106). The test information, once debugged, can then be exported (step 1108) to produce an unofficial design document based on the test specifications actually in use (step 1110). A designer may then review or edit this new document and release an official design document based on the modifications (step 1112). The process may then be repeated with the new design document.

Exporting of edited test program values back into the design documentation may be desirable in a product development phase when a preliminary test requirements design document is edited at the test program level to refine the requirements. This process should be done under strict control so that the official design documentation remains under the control of the designer. By making the official design documentation file read-only, the exported test program requirements can be exported only to an unofficial file for later review/editing and ultimate official release by the designer.

It is important to note that while the present invention has been described in the context of a fully functional data processing system, those of ordinary skill in the art will appreciate that the processes of the present invention are capable of being distributed in a variety of forms of computer readable media containing functional descriptive material and that the present invention applies with equal force regardless of the particular type(s) of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio-frequency and lightwave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A method comprising:
reading data containing a set of test specifications, wherein the data is in a structured format; and
translating the data from the structured format into a second format for use in test software.

2. The method of claim 1, wherein translating the data the data from the structured format into the second format includes:
assembling a variable list from values contained in the data; and
writing the variable list into a data structure of the test software.

3. The method of claim 2, wherein the data structure is contained within a file on a storage device.

4. The method of claim 2, wherein the data structure is contained within memory.

5. The method of claim 1, wherein the structured format is a table.

6. The method of claim 5, wherein the table is contained in a spreadsheet document.

7. The method of claim 6, wherein the spreadsheet file contains a plurality of worksheets.

8. The method of claim 6, wherein the spreadsheet document is in Microsoft Excel format.

9. The method of claim 5, wherein the table is embedded in a word-processor document.

10. The method of claim 1, wherein the structured format is a markup language.

11. The method of claim 10, wherein the markup language is Extensible Markup Language (XML).

12. The method of claim 1, further comprising:
determining whether a particular test specification is absent from the data;
in response to a determination that the particular test specification is absent from the data, supplying a default value for the particular test specification.

13. The method of claim 1, wherein the data includes master rules that establish constants or formulas.

14. The method of claim 1, wherein the data includes at least one of a product platform, a product code, and a revision number.

15. The method of claim 1, wherein the data includes a test list that includes a plurality of tests.

16. The method of claim 1, wherein the plurality of tests are associated with at least one of a test name, a test method, a test description, test conditions, test limits, and a numerical precision.

17. The method of claim 1, further comprising:
initiating execution of the test software to use the data in the second format.

18. The method of claim 1, wherein the test specifications are associated with a machine.

19. The method of claim 18, wherein the machine is a circuit.

20. The method of claim 19, wherein the circuit is a power supply.

21. A computer program product in a computer-readable medium comprising functional descriptive material that, when executed by a computer, enables the computer to perform acts including:
reading data containing a set of test specifications, wherein the data is in a structured format; and
translating the data from the structured format into a second format for use in test software.

22. The computer program product of claim 21, wherein translating the data the data from the structured format into the second format includes:
assembling a variable list from values contained in the data; and
writing the variable list into a data structure of the test software.

23. The computer program product of claim 22, wherein the data structure is contained within a file on a storage device.

24. The computer program product of claim 22, wherein the data structure is contained within memory.

25. The computer program product of claim 21, wherein the structured format is a table.

26. The computer program product of claim 25, wherein the table is contained in a spreadsheet document.

27. The computer program product of claim 26, wherein the spreadsheet file contains a plurality of worksheets.

28. The computer program product of claim 26, wherein the spreadsheet document is in Microsoft Excel format.

29. The computer program product of claim 25, wherein the table is embedded in a word-processor document.

30. The computer program product of claim 21, wherein the structured format is a markup language.

31. The computer program product of claim 30, wherein the markup language is Extensible Markup Language (XML).

32. The computer program product of claim 21, comprising additional functional descriptive material that, when executed by a computer, enables the computer to perform additional acts, including:
determining whether a particular test specification is absent from the data;
in response to a determination that the particular test specification is absent from the data, supplying a default value for the particular test specification.

33. The computer program product of claim 21, wherein the data includes master rules that establish constants or formulas.

34. The computer program product of claim 21, wherein the data includes at least one of a product platform, a product code, and a revision number.

35. The computer program product of claim 21, wherein the data includes a test list that includes a plurality of tests.

36. The computer program product of claim 21, wherein the plurality of tests are associated with at least one of a test name, a test computer program product, a test description, test conditions, test limits, and a numerical precision.

37. The computer program product of claim 21, comprising additional functional descriptive material that, when executed by a computer, enables the computer to perform additional acts, including:
initiating execution of the test software to use the data in the second format.

38. The computer program product of claim 21, wherein the test specifications pertain to functioning of a machine.

39. The computer program product of claim 38, wherein the machine is a circuit.

40. The computer program product of claim 39, wherein the circuit is a power supply.

41. A data processing system comprising:
means for reading data containing a set of test specifications, wherein the data is in a structured format; and
means for translating the data from the structured format into a second format for use in test software.

42. The data processing system of claim 41, wherein translating the data the data from the structured format into the second format includes:
assembling a variable list from values contained in the data; and
writing the variable list into a data structure of the test software.

43. The data processing system of claim 42, wherein the data structure is contained within a file on a storage device.

44. The data processing system of claim 42, wherein the data structure is contained within memory.

45. The data processing system of claim 41, wherein the structured format is a table.

46. The data processing system of claim 45, wherein the table is contained in a spreadsheet document.

47. The data processing system of claim 46, wherein the spreadsheet file contains a plurality of worksheets.

48. The data processing system of claim 46, wherein the spreadsheet document is in Microsoft Excel format.

49. The data processing system of claim 45, wherein the table is embedded in a word-processor document.

50. The data processing system of claim 41, wherein the structured format is a markup language.

51. The data processing system of claim 50, wherein the markup language is Extensible Markup Language (XML).

52. The data processing system of claim 41, further comprising:
means for determining whether a particular test specification is absent from the data;
means responsive to a determination that the particular test specification is absent from the data, for supplying a default value for the particular test specification.

53. The data processing system of claim 41, wherein the data includes master rules that establish constants or formulas.

54. The data processing system of claim 41, wherein the data includes at least one of a product platform, a product code, and a revision number.

55. The data processing system of claim 41, wherein the data includes a test list that includes a plurality of tests.

56. The data processing system of claim 41, wherein the plurality of tests are associated with at least one of a test name, a test data processing system, a test description, test conditions, test limits, and a numerical precision.

57. The data processing system of claim 41, further comprising:
means for initiating execution of the test software to use the data in the second format.

58. The data processing system of claim 41, wherein the test specifications are associated with a machine.

59. The data processing system of claim 58, wherein the machine is a circuit.

60. The data processing system of claim 59, wherein the circuit is a power supply.
